(19) United States
(12) Patent Application Publication
(10) Pub. No.: US 2004/0020871 A1
(43) Pub. Date: Feb. 5, 2004

(54) Method of filtering fluids

(75) Inventors: John R. Hampton, Houston, TX (US); Greg P. Wallace, Katy, TX (US)

Correspondence Address: Margaret A. Boulware, Jenkens & Gilchrist, Ste. 1800, 1100 Louisiana, Houston, TX, 77002, US

(73) Assignee: Filtration Technology Corporation, Houston, TX (US)

(21) Appl. No.: 10/629,089

(22) Filed: Jul. 29, 2003

Related U.S. Application Data
(62) Division of application No. 09/887,392, filed on Jun. 22, 2001.

(51) Int. Cl. B01D 17/02

(52) U.S. Cl. 210/799; 210/804

(57) ABSTRACT

A method of filtering fluids with different specific gravities as well as particles or other impurities.

### CROSS-REFERENCE TO PRIOR APPLICATIONS

This is a divisional application claiming benefit of U.S. application Ser. No. 09/887,392, filed Jun. 22, 2001, which is incorporated by reference herein in its entirety.

### FEDERALLY SPONSORED RESEARCH STATEMENT

Not applicable.

### REFERENCE TO AN APPENDIX

Not applicable.

### BACKGROUND OF THE INVENTION

This invention relates to the filtration of fluids including mixtures of more than one fluid and fluids with solids.

Filters and methods of filtration are widely utilized in a number of commercial and industrial applications and also in laboratory, clinical and residential settings. Such filters and methods may be used to both purify fluids (e.g., liquids and gases) and to extract compounds (e.g., fluids and solids) contained in the fluids.

There are instances where a fluid is a mixture of the desired fluid and another fluid deleterious to the use of the desired fluid. This is the case with diesel fuel which often is contaminated with water, which is harmful to a diesel engine. There are systems which are designed to remove contaminates, such as the water, with a hygroscopic material designed to trap the water. Often the water is allowed to accumulate in the pumps of the diesel fueling system that may have a particle filter, but no way to remove water from the fuel.

In some cases, the offending fluid can adversely affect the filter media and render the filter ineffective for the intended purpose. To combat this problem some filter systems have elaborate designs to protect the filter element and isolate the offending fluid from the filter.

### SUMMARY OF THE INVENTION

In general, one of the aspects of the invention features an outside/in filter element with a sleeve of material that is substantially non-permeable to fluids that surrounds a portion of one end of the filter element. The filter element has a core member that is in fluid communication therewith. In another embodiment the sleeve can surround substantially all of the filter element and has perforations in the sleeve toward one end of the filter element. The core is surrounded by the filter element and is designated as a central core. The core can be a rigid material. Further, the core may have perforations to allow fluid communication. The filter's construction allows for the separation of fluids with different specific gravities when placed in a housing such that the lighter or heavier fluid passes through the filter through the perforation on the sleeve or the portion of the filter not covered by the sleeve into the filter media.

The filter media is in fluid communication with a central core, and the filter fluid passes into the central core. The filter media may be surrounded by a rigid support such as a mesh.

The filter can be placed in a housing with a fluid inlet and fluid outlet. The fluid outlet of the housing is in communication with the central core through which the filtered fluid passes. In one embodiment the filter has an end cap which the filter element abuts and has a cylindrical extension which is in fluid communication with the outlet of the housing. The outside of the cylindrical extension of the end cap has a seal member which is adapted to be coupled to the inside of the outlet of the housing. The seal member may be a gasket which is seated tightly so there is fluid flow from the core of the filter out of the housing without leakage.

The filter of the present invention may also be an inside/out filter. In this embodiment the fluid enters through the central core and flows outward through the filter element. The central core acts as a substantially fluid non-permeable barrier to the filter element in the inside/out filter. The central core extends from one end of the filter exposing either the upper or lower portion of the filter to the fluid. In an alternative embodiment the central core has a portion either at the upper or lower end of the filter which is in fluid communication with the fluid by perforations or other means.

The filter may be placed in a housing which has an inlet and outlet for fluids. The fluid passes through the inlet into the central core. Depending on which fluid is desirable, the heavier or lighter component of a mixed fluid, the central core exposes either the top or the bottom of the filter element. If the preference is to remove the heavier fluid, the bottom of the filter is covered by the substantially fluid non-permeable core. The top of the filter is totally exposed or in fluid communication with the lighter fluid due to the heavier fluid remaining toward the inflow or bottom of the central core due to the difference in specific gravity. If the heavier fluid is desirable, then the bottom of the filter media is exposed by perforating the central core or having the central core extend from the top of the filter element and terminating so that a portion of the filter media is exposed to the fluid at the inlet end of the filter. The desired fluid flows through the filter media, where undesired particles or other matter or fluids are removed. The filter fluid is collected in a space between the filter element and the housing and flows through the outlet on the housing. A top cap may cover the top of the central core to confine the fluid inside the central core.

Different media may be used as the filter element. Basically, the media are pleated filter media and non-pleated media. The filter media may be selected to separate undesirable materials from the fluid whether particles or liquid. The pleated media can include cellulose, polypropylene, polyethylene, polyester, fiberglass, cloth, paper, nylon, orlon, teflon or combinations thereof. The non-pleated media can be granular media, spunbonded media or solid media. The media can be surrounded by a rigid support such as a mesh. In the case of granular media, a mesh to confine the granules is preferable.

### DETAILED DESCRIPTION OF THE DRAWINGS

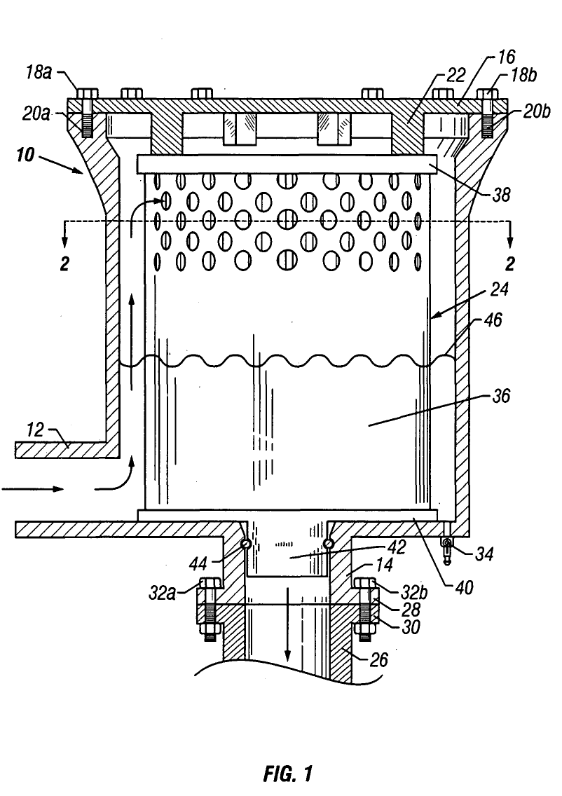

FIG. 1 is a view of the filter element installed in a housing, with the housing cut away.

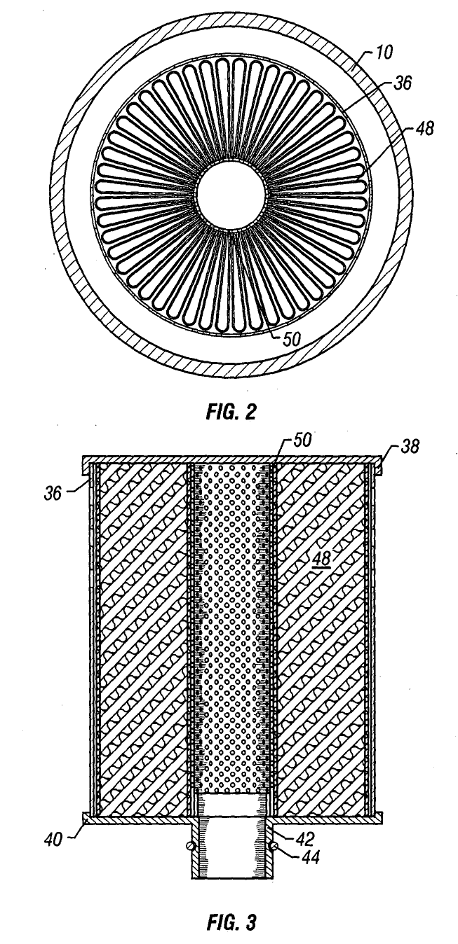

FIG. 2 is a cross-section of the filter element shown in FIG. 1 at 2-2.

FIG. 3 is a longitudinal section of the filter.

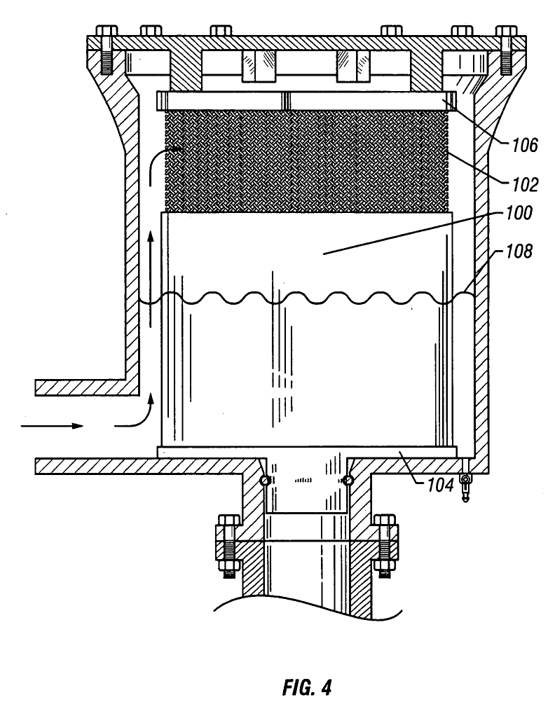

FIG. 4 is a view of an alternate embodiment of the filter installed in a housing with the housing cut away.

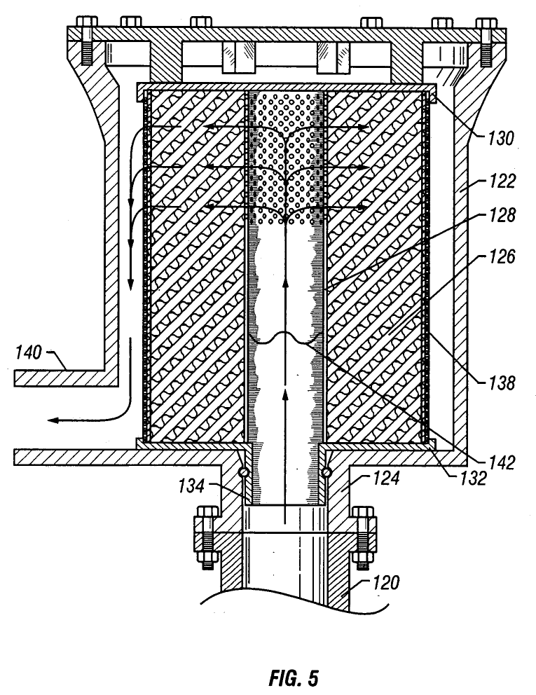

FIG. 5 is a longitudinal section through an alternate embodiment of the filter installed in a housing.

### DETAILED DESCRIPTION OF THE INVENTION

The filter element of the present invention is typically installed in a housing into which fluids are directed. The housing is connected to a fluid source such as a tank or other storage facility containing a mixture of fluids with contaminants such as other fluids and/or particles. The housing containing the filter does not need to be connected to a tank or storage facility. The filter can be in communication with fluid flow stream in an industrial facility or plant. The filter can also be incorporated into a vehicle or craft for fuel or other fluid filtration.

FIG. 1 shows the filter element in a generally cylindrical housing 10 for the purposes of illustrating the invention. As described above, the placement and use of the filter element of this invention is not limited to the housing environment shown in FIG. 1. For ease of reference, the housing will be generally indicated by numeral 10 in all of the figures. FIG. 1 shows a typical arrangement for a connection of inlet line or pipe 12 for delivery of a fluid, as shown by the arrows, into housing 10. The housing has outlet line or pipe 14 on the bottom of the housing for the outflow of the filtered fluid.

The housing 10 has a removable, generally circular lid 16 which is secured to the top of housing 10 to prevent fluid from flowing out the top of the housing. Also, the lid 16 can be removed to change the filter. In an alternative embodiment, the lid 16 can be omitted and the housing could be a unitary part without a lid. Alternatively, the entire housing assembly could be replaced with the housing and the filter permanently installed in the outer housing. In FIG. 1, lid 16 is secured to the side of the housing with screws shown in cross section illustrated at 18a, 18b, which are threaded through the lid 16 into the wall of the housing which has openings to receive the screws at 20a, 20b. The screws are placed around the top perimeter of the lid 16. However, any other method to secure the lid to the housing may be used as known to those skilled in the art. As shown in FIG. 1, the lid 16 also is provided with a circular extension 22 on the inside of the lid 16 which is adapted to abut the top of the filter generally indicated by numeral 24 to secure the filter in the housing 10.

The housing 10 can be secured at outlet line 14 to a separate outlet line 26 for fluid outflow. As shown in FIG. 1, the outlet line 14 on housing 10 has a flange 28 which corresponds to flange 30 on the outlet line 26. Screws 32a and 32b are threaded through the flanges 28 and 30 to provide a secure connection to prevent fluid leakage of outflow from the housing. Of course, any other method to secure the outlet of housing 10 can be used to connect the outlet for the fluid. In some cases a flexible tubing or other type of outlet can be connected to the housing. In FIG. 1 a valve 34 is shown on the bottom of the housing which may be selectively activated to release fluid from the inside of the housing 10.

The filter element 24 of this invention can be placed in a housing as shown in FIG. 1 or otherwise as will be readily understood by those skilled in the art. As shown in FIG. 1, fluid enters the housing through inlet 12. Filter element 24 has a non-permeable sleeve 36 which surrounds the filter media. Sleeve 36 is affixed at the top to end cap 38 of the filter which abuts the internal circular extension 22 of lid 16, and sleeve 36 is affixed on the other end of the filter assembly to bottom end cap 40. As shown in FIG. 1, bottom end cap 40 has a neck-like central cylindrical extension 42 which communicates with outlet line 14 of the housing. The extension 42 is secured inside inlet line 14 by an o-ring 44 or other gasket means.

The fluid coming into the housing enters the filter element 24 through a series of perforations in sleeve 36 as shown in FIG. 1. The perforations in sleeve 36 are toward the top of the sleeve adjacent to the top end cap 38. The pattern, size and number of perforations can be varied depending on the application. There is a portion of the sleeve 36 without perforations toward the bottom end cap 40. As fluid enters the housing which can be a mixture of at least two fluids with different specific gravities, the heavier fluid will settle to the bottom of the housing leaving the lighter fluid to rise and enter the perforations in the sleeve 36 toward the top of the filter and flow through the filter media. In FIG. 1 there is a line drawn and indicated at numeral 46 for the line of phase separation for the two fluids. As more fluids of mixed specific gravity enter the housing, the heavier fluid builds up in the housing outside the unperforated portion of the sleeve. Valve 34 can be activated to release the heavier fluid from inside housing 10 to allow for more separation to occur as the mixed fluid enters the housing. Also, the housing may be adapted with a clear site glass on the side to visually observe the buildup of heavy fluid inside the housing. The inlet pipe 12 may be placed higher on the wall of the housing so the lighter part of the fluid component does not flow through the heavy component entry into the housing.

FIG. 2 shows a cross-section through lines 2-2 of FIG. 1. The filter 24 is shown in housing 10. The filter media illustrated is a pleated media 48 which is between the sleeve 36 and a central perforated cylindrical core 50 which extends from top end cap 38 to bottom end cap 40 and communicates with central cylindrical extension 42 of bottom end cap 40. The top end cap 38 covers the top of core 50. The core size is variable depending on the application. The media can be any type of filter media known to those skilled in the art for filtering particles or removing undesired fluids. Also, combinations of filter media can be used depending on the applications. Examples of other filter media include wrapped, solid or granular media. The invention is not limited to any type of filter media. The pleated media can be made of cellulose, other paper materials or polymers, such as polyethylene or polypropylene. The wrapped media can be made of spun bonded material, cloth, fiberglass, polypropylene, polyester and combinations thereof Granular media such as carbon may be used.

It is preferable to have some spacing between the inside of sleeve 36 and the outer edges of media 48 to minimize flow restriction into the media. The media may be packed as tightly or loosely as desired. FIG. 2 shows pleated media in the filter. As described above, different filter media and combinations or layers of different media may be used.

FIG. 3 is a cross-section through the filter 24. The top end cap 38 is shown covering the top of the pleated filter media 48 and core 50. The top end cap has a short overhang or lip which encircles the top of sleeve 36. The sleeve 36 and core 50 can be secured to the end cap with glue such as epoxy, heat bonded or a mechanical means of fastening. Bottom end cap 40 is shown with central cylindrical extension 42 for outflow of filtered fluid which is in communication with core 50. Bottom end cap 40 is shown with an overhang or lip which encircles and secures the bottom of sleeve 36. Sleeve 36 and core 50 are glued, heat bonded or mechanically fastened to bottom end cap 40. Central cylindrical extension 42, which functions as the outflow for filtered fluid, is shown with an o-ring 44 used to secure the filter element to the outflow line of the housing.

FIG. 4 illustrates some alternative embodiments of the present invention. The modification of the prior embodiment includes a sleeve 100 which partially covers the filter media. The sleeve can be any height desired as long as access to the filter media is provided. In FIG. 4 the filter media is surrounded by a mesh 102 which does not hamper the fluid flow. The mesh can be made of polymer. The bottom end cap 104 is fastened and secured to the sleeve 100 by a glue, heat bonded or mechanical means. There is a central core (not shown) which is fastened to top end cap 106 and bottom end cap 104. Phase separation is shown at line 108 for illustrative purposes.

FIGS. 1 through 4 illustrate outside/in flow with the fluid entering the housing and flowing from outside the filter through the core and out the housing. In FIGS. 1 through 4, the undesirable fluid is the heavier fluid, such as water contaminate, in a lighter fluid, such as diesel fuel. The same invention can be used for inside/out flow if the heavier fluid is desired. The perforations on the sleeve would be in the bottom of the sleeve so the heavier fluid settling out inside the housing would enter the filter media, while the lighter fluid would be confined to the top of the housing adjacent the unperforated part of the sleeve. Similarly, a solid sleeve could be used to shield the top of the filter media, leaving a portion of the bottom of the filter media uncovered for fluid access.

FIG. 5 shows an embodiment of the invention for an inside/out flow. The inlet line 120 delivers a fluid, such as a mixed fluid, and/or particles into housing 122 through communication with cylindrical housing inlet 124 at the bottom of the housing 122. The filter is secured in the housing as previously described. The filter has a central core 128 which is secured to and covered by top end cap 130 and bottom end cap 132 and in communication with neck-like central cylindrical extension of end cap 134. The central core 128 is perforated towards the top of the filter. The fluid, which can be a mixed fluid with and/or containing particles, flows from the inlet line 120 through the housing inlet 124 which is in communication with the central core 128 through the neck of end cap 132 which is secured inside the housing inlet 124. The lighter fluid flows upward through the central core and enters the filter media 126. In FIG. 5 the phase separation line is indicated at numeral 142. The lighter fluid flows through the filter media. In FIG. 5 the filter media is shown as pleated paper media which is surrounded by mesh 138. For granular or powdered media, a tight mesh or other rigid support, such as a sleeve that permits fluid communication with the media, can be used. The lighter weight fluid flows into the housing in the space between the inner housing wall and the filter and out the outflow line 140.

The same filter setup in FIG. 5 could be used to separate heavier fluids that have a contaminate of lighter fluid. The central core 128 could be perforated towards the inflow line and bottom end cap 132. The heavier fluid would flow through perforations of the central core through the filter media while the lighter fluid would flow upward in the central core and be confined in the central core by top end cap 130.

An alternative of the inside/out flow filter includes a non-permeable central core which extends through a portion of the filter media, thereby exposing either the top or bottom of the filter media to fluid communication depending on whether the heavier or lighter fluids are desired.

Other embodiments are within the scope of the claims.

What is claimed is:

1. Canceled.

2. Canceled.

3. Canceled.

4. Canceled.

5. Canceled.

6. Canceled.

7. Canceled.

8. Canceled.

9. Canceled.

10. Canceled.

11. Canceled.

12. Canceled.

13. Canceled.

14. Canceled.

15. Canceled.

16. Canceled.

17. Canceled.

18. Canceled.

19. Canceled.

20. Canceled.

21. Canceled.

22. Canceled.

23. Canceled.

24. Canceled.

25. Canceled.

26. Canceled.

27. Canceled.

28. Canceled.

29. Canceled.

30. Canceled.

31. Canceled.

32. Canceled.

33. Canceled.

34. Canceled.

35. Canceled.

36. Canceled.

37. Canceled.

38. Canceled.

39. Canceled.

40. Canceled.

41. Canceled.

42. Canceled.

43. Canceled.

44. Canceled.

45. A method of filtering fluids comprising the steps of
(a) flowing at least two fluids into a housing;
(b) passing the fluids around a filter element partially surrounded by an a non-permeable barrier at the lower end of the filter element;
(c) allowing the fluids to separate by gravity so that the lighter fluid can flow above the sleeve in the housing above the barrier;
(d) further passing the lighter fluid through a filter media;
(e) collecting the lighter fluid after passing through the filter element; and
(f) collecting the heavier fluid in the housing.

46. A method of filtering fluids of claim 45 wherein the fluid mixture contains solids and additionally filtering the solids by the filter element.

47. A method of filtering fluids comprising the steps of:
(a) flowing at least two fluids into a housing;
(b) passing the fluids around a filter element partially surrounded by an a non-permeable barrier at the upper end of the filter element;
(c) allowing the fluids to separate by gravity so that the lighter fluid can flow above the sleeve in the housing adjacent to the barrier;
(d) further passing the heavier fluid through a filter media;
(e) collecting the heavier fluid after passing through the filter element; and
(f) collecting the lighter fluid in the housing.

48. A method of filtering fluids of claim 47 wherein the fluid mixture contains solids and additionally filtering the solids by the filter element.
